(19) United States
(12) Patent Application Publication
(10) Pub. No.: US 2024/0320715 A1
(43) Pub. Date: Sep. 26, 2024

(54) PLATFORM FOR FACILITATING COMMUNICATION BETWEEN CUSTOMER DEVICES AND BACK-END SERVER FOR RETAIL LOCATION

(71) Applicant: Bonder, Inc., San Jose, CA (US)

(72) Inventor: Scott Swanson, San Jose, CA (US)

(21) Appl. No.: 18/736,130

(22) Filed: Jun. 6, 2024

Related U.S. Application Data
(63) Continuation-in-part of application No. 17/467,874, filed on Sep. 7, 2021, now Pat. No. 12,008,607.
(60) Provisional application No. 63/074,629, filed on Sep. 4, 2020.

(51) Int. Cl. G06Q 30/02; G06Q 30/0207; G06Q 30/0251; G06Q 30/0601; G06Q 50/00; H04W 4/021

(52) U.S. Cl. CPC G06Q 30/0281; G06Q 30/0239; G06Q 30/0261; G06Q 30/0641; G06Q 50/01; H04W 4/021; G06Q 2220/00

(57) ABSTRACT

Systems and methods for networking customer devices with each other and with retail location servers are described herein. A server (e.g., a server associated with a retail location) may determine that a first device is in proximity of a retail location, where the first device is associated with a customer user. The server may then transmit a customer GUI includes data indicative of products sold in the retail location and sections of the retail location. The server may then subsequently transmit an invitation to join private circle associated with the retail location. In response to the customer joining the private circle, a circle GUI may be transmitted to the first device providing selectable links to other customer users and event webpages. Furthermore, interactions between customer devices and the various GUIs provided may be tracked to provide real-time analytic data to better track retail location performance.

### RELATED APPLICATIONS

The present application is a continuation-in-part of U.S. application Ser. No. 17/467,874, entitled Connecting Customers to Employees, filed on Sep. 7, 2021, now U.S. Pat. No. 12,008,607, granted Jun. 11, 2024, which claims priority to U.S. Provisional Patent Application Ser. No. 63/074,629, entitled Connecting Customers to Employees, filed on Sep. 4, 2020, each of which are incorporated by reference along with all other references cited in this application.

### TECHNICAL FIELD

This disclosure relates to location-based device communications, and in particular facilitating communicating with and tracking customer devices prior to entering a retail location, while the device is at the retail location, and after the device exits the retail location.

### BACKGROUND

Retails stores often have websites or applications that allow potential customers to see details regarding the products available for sale. The website or application may include details such price, dimensions, delivery time, and other related details. Nevertheless, a potential customer may have specific or additional questions regarding one or more products. To get these questions answered, the potential customer may call the store or to the store to get their questions answered by a knowledgeable employee.

### SUMMARY

Some of subject matter described here includes a method of connecting customers with employees of a retail business, the method comprises, at least some of the following steps. Determining, by a server, that a first device is in proximity of a retail business, the retail business being associated with the employee and the first device being associated with the customer, wherein determining that the first device is in proximity further includes: determining a geolocation of the first device; generating a geofence around the retail business; and determining that the first device is within the geofence. Retrieving, by the server, from a repository associated with the retail business, data indicative of the products sold in the retail business and of the sections in the retail business. Transmitting, by the server, a first set of data indicative of a customer graphical user interface (GUI) to the first device, wherein the customer GUI includes the products and sections. Transmitting, by the server, instructions to display the customer GUI on a display of the first device. Transmitting, by the server, a second set of data indicative of an employee GUI to the second device and instructions to display the employee GUI on a display of the second device. In response to the customer selecting, on the customer GUI, a first product or a first section, establishing, by the computing device, a communication channel between the first device and a second device associated with the employee, wherein the employee is associated with the first product or first section. In response to establishing the communication channel, transmitting, by the server, a chat GUI to the first device and the second device, wherein the chat GUI is operable to transmit communication data over the communication channel. And storing, by the server, the communication data from the chat GUI.

### BRIEF DESCRIPTION OF THE DRAWINGS

FIG. 1 is a block diagram of an environment in which the disclosed embodiments can be implemented.

FIG. 2 is a flowchart of the process from the perspective of the customer device.

FIG. 3 is a block diagram of the exchange between the customer and retail employee devices.

FIG. 4 is an embodiment of a graphical user interface from a customer perspective.

FIG. 5 is an embodiment of a chat GUI.

FIG. 6 is a block diagram illustrating a diagrammatic representation of a machine in the example form on a computer system operable to perform aspects of the disclosed technology.

FIG. 7 shows a flow diagram of a method of networking customer devices with each other and with retail location servers, according to an embodiment.

FIG. 8 is a screenshot from a circle GUI providing selectable links to other customer users and event webpages, according to an embodiment.

FIGS. 9A-B are screenshots from a customer GUI including selectable chat links to other customer users and a chat GUI respectively, according to various embodiments.

FIGS. 10A-C are screenshots from a chat GUI displaying a process for gifting gift cards to a retail location, electronic currency, and/or cryptocurrency, according to various embodiments.

FIG. 11 is a screenshot from a customer GUI displaying an event webpage that includes a selectable link to a livestreamed event, according to an embodiment.

FIG. 12 is a screenshot from a customer GUI displaying a livestreamed event, according to an embodiment.

FIG. 13 shows a flow diagram of a method of tracking interactions between customer devices and retail location servers, according to an embodiment.

FIG. 14 is a screenshot from an analytics GUI displaying information from a real-time analytics dataset, according to an embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts that are not particularly addressed herein. It should be understood that these concepts and applications fall within the scope of the disclosure and the accompanying claims.

The purpose of the terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, refer to any connection or coupling, either direct or indirect, between two or more elements. The coupling or connection between the elements can be physical, logical, or a combination thereof.

Retail businesses are a large part of many people's day to day lives. Even with the progress of online shipping and delivery businesses, it has become second-nature to go to retails stores to view merchandise, return purchased merchandise, view options, or the like. In many ways the retails business experience has not changed in decades. A potential customer enters a store, looks for an item they interested in, and they buy it. Or in some situations, the potential customer has a question and they find an employee of the store to get their questions answered. Due to this stagnation in the in-person retail experience, among other issues, customers have elected to spend their online shopping, while accepting to forego the advantage in-person shopping. However, the present disclosure addresses some issues, described below, that will help better the in-store shopping experience.

First, the level of customer engagement with a retail business needs to be improved. Currently, a customer interacts with a retail business in one of three ways: in-person at the store, a phone call, or online. For example, a customer may go to a store looking to buy a new laptop. Once at the store, the customer may wander through the section with the laptops and may have some questions. They then look for an employee by wandering through aisles, and once they find an employee, the employee may not be the most knowledgeable employee about laptops. Similarly, the same issue can occur over the phone or online. In other words, the customer has no way to know who to approach about particular products.

Second, the buying experience, especially when compared to online shopping, is not worthwhile for many customers. The buying experience, in the current state of the art, has not been updated in decades. The buying experience is fairly generic: decide to buy a product, go to an appropriate store, find the product, check-out. This process is inundated with issues such as low efficiency, frustration from trying to find the right product, and other issues. For example, a customer may want to buy shoes with a particular color scheme. However, once in a shoe store, they have to look through boxes or find an employee and describe the colors to them. The similar process can be applied to other products such as cell phones, bags, clothing, and other products that have varying features. As such, the buying experience is marred with a combination of negative events and/or interactions.

Third, the post-purchase experience leaves many customers wanting more. For example, currently, when a customer buys a product and leaves the store, they are rarely provided further support. They are provided with a customer support number or website but need to come back to the store to address any additional issues. For instance, if a customer interacts with a sales representative at the store who convinces them to buy a product that requires assembly, the customer has no way to contact that representative unless they go back to the store. In many cases, the customer may have questions about how to assemble the product, or the customer needs help finding a part that was missing in the original packaging. As such, the post purchase experience is not affiliated with place of purchase, but rather a detached third-party service such as a customer service center.

The present disclosure addresses these and other issues by providing a platform to enable interaction between a customer and an employee. The platform can be a smart application that can be used on a network-connected device. The platform can include a geolocation feature that detects the location of a customer and provides portals (e.g., GUIs, webpages, or application windows) for each of the stores located nearby. Subsequently, the customer can choose a particular store and view the products by the store. In some embodiments, the products can be categorized based on intended use, manufacturer, or other appropriate categories. Once the customer selects a product or category, the customer may be prompted to interact with as employee of the store. If the customer elects to do so, the platform establishes a communication channel between the customer and the employee. In some embodiments, the communication channel can be between the customer and all the employees of the store. The employee with the expertise in the product or category that the customer selected, will then communicate with the customer. This can include finding the product, prompting a purchase via the platform, and leaving the product at a pick-up for the customer. Moreover, the communication channel remains active after the purchase, which allows the customer to follow-up with post-purchase questions directed to the same employee.

For example, a customer can go to a Best Buy store. The platform will recognize, once the customer's device is within a certain distance of the store, that the customer is near Best Buy. Subsequently, the platform will populate the Best Buy store details on the platform (e.g., via a separate GUI, webpage, or window). For instance, the platform can list all of the departments for the Best Buy store in the customer's current location. The customer, after or before entering the store, can post a question in a particular department. The question can be sent to all the employees of the store, the employees within that department, or to a particular employee. After doing so, the customer can get an answer on the platform from a particular employee, via a digital message, video call, audio message, or get in-person assistance. After the customer returns home, the customer will still have direct messaging contact to the particular employee they spoke to earlier.

### Environment

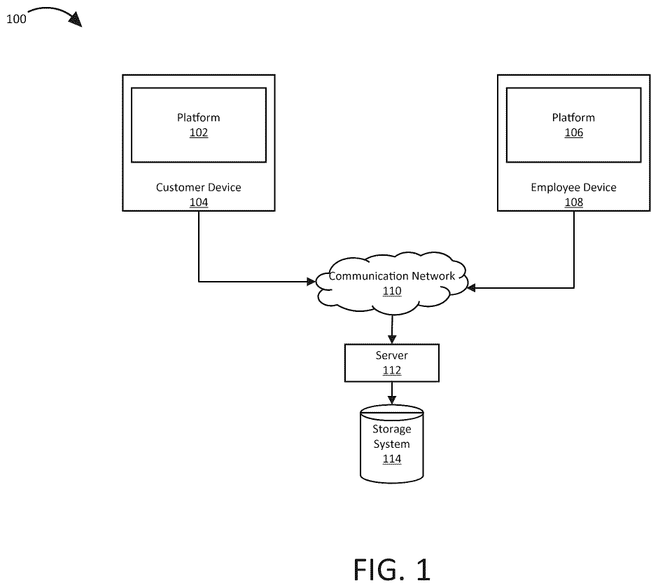

Turning to FIG. 1, FIG. 1 is a block diagram of an environment 100 in which the disclosed embodiments can be implemented. In FIG. 1, customer can use customer device 104 to use platform 102. Similarly, employee can use employee device 108 to use platform 106. In some embodiments, platform 102 and 106 can be a smart application, for use on network-connected devices such as customer device 104 and employee device 108. Server 112 and/or storage system 114 can store an executable file for generating the application. The executable file can also be stored at a different location. A customer and employee can subsequently download the application on their devices (i.e., 104 and 108). The user device 104 and 108 can be any network-connected computing device capable of accessing the server 112 over a communication network 110 and capable of sending necessary data, such as a laptop, smartphone, tablet, etc.

The following paragraphs describe embodiments from a user-side portion of the communication platform which is implemented as a smart application (also referred to as “platform”). Each user of the platform can download the application on their respective devices. For example, a customer using customer device 104 can download platform 102 onto customer device 104. By doing so, the customer can communicate to the employee as required to provide sufficient information during a pre-purchase or post-purchase interaction.

For example, a customer may be parked in the Home Depot parking lot. Rather than go into the store and look for an item (e.g., paint or tools), the customer can use platform 102 to connect with an employee in a desired section of the Home Depot. In some embodiments, the platform 102 can automatically detect, based on the geolocation, that the user is near a Home Depot. Accordingly, the platform 102 can populate the sections, products, and other details about the Home Depot. The customer can then connect with an employee from a particular section and request a particular product, or simply ask questions.

In some embodiments, the platform 102 and platform 106 are the same smart application. However, each user can select a profile based on their role. For example, a customer, during the initial set-up of the platform 102 on customer device 104, can select that they are a customer. This can lead to a different user experience (e.g., via a different GUI) such as having access to multiple stores and being able to contact store employees. Alternatively, an employee can select an employee profile (e.g., employee GUI). This can include, for example, registering using the company email, getting permission from an account holder, or the like. The employee may then have access to altering available products, setting their expertise categories/level, and connecting with customers on the platform.

For example, server 112 and/or storage system 114 may store a registry of employee names and emails for certain businesses. The businesses can register themselves onto the platform or the platform can populate the information from other sources. Thus, when an employee uses platform 106, he/she can log in using the company email ID, name, employee number, or other identification.

In FIG. 1, the user (e.g., customer and employee) can select a personal profile and be presented with a modified GUI on platform 102 and 106. The GUI be representative of the profile. In other words, a customer would see a different GUI than the employee. For example, the GUI on a platform 102 may show a customer the nearby stores, the available products, and sections of the store. The GUI on platform 106 may show an employee incoming questions from customers, fellow employees asking for help, or other interactions that normally occur in-store between employees and customers and between co-employees.

In some embodiments, server 112 and/or storage system 114 can be local with respect to the store, customer device 104, and/or employee device 108. For example, each store can have its own server and/or storage system such that the platform 102 has to connect via communication network 110 to the local server and/or storage system to retrieve the details about the store (e.g., employee registry, sections, or products). For instance, the connection can be automatically triggered based on proximity of customer device 102 or based on a previous connection.

In some embodiments, environment 100 facilitates an interaction between customer device 104 and employee device 108. Customer device 104, upon being in proximity to a store, can populate a GUI with the store details on platform 102. The customer can then elect to contact an employee at the store. The customer can do so, for example, after selecting a particular product, a section of the store, or another filter. Upon contact, the customer device 104, via communication network 110, can establish a communication channel with employee device 108. This can result in an alert from platform 106 appearing on employee device 108. The employee, via platform 106, can enter a chat GUI to interaction with the customer.

In some embodiments, when the customer wants to interact with an employee, the platform 102 opens a communication channel with all the employees in the store. On the employee's side, each employee receives an alert and the GUI can prompt each employee to take responsibility for the customer request. For example, a customer, outside of a Best Buy, can ask for help with selecting the best noise cancelling headphones. The request can be sent to every employee of the Best Buy near the customer's location. The employees can receive an alert, with a prompt to indicate that they'll take responsibility. After which, the employee with knowledge about the subject matter of the request can take responsibility. In some embodiments, when a request has been unanswered for a certain time period (e.g., over five minutes), the platform 106 can escalate the issue. For example, the platform 106 can alert the employee(s) again or alert a higher-level employee.

In some embodiments, the server 112 and/or storage system 114 can store the data from an interaction to allow for post-purchase or other future interaction between the parties. For example, a customer can ask a question about a laptop at Best Buy on platform. An employee, via platform 106, can address the question and subsequently, the customer can purchase the laptop. The customer, a few a days later, may have questions about using the laptop, additional features, or the like. To get these questions answers, the customer can use platform 102 to reopen the conversation with the same employee. In this way, all the histories of interactions can be stored in the server 112 and/or storage system 114 and reopened at a later time.

In some embodiments, the platform 102 and 106 can include a payment GUI. The payment GUI can facilitate a purchase without have the customer come into the store. For example, a customer can be chatting with a Home Depot employee regarding a type of tile. The employee may inform the customer that it is available. The customer can then ask the employee to proceed with the purchase of the tile. The employee can then use platform 106 to, for example, input the item or scan the barcode to on the payment GUI. Platform 102 can then reflect the to-be-purchased items, and the customer can make the purchase as they would in any other online-shopping scenario. After the transaction has completed, the platform 106 can provide an alert to the employee, and he/she can drop-off the purchases tiles in a pick-up area.

### Method of Use

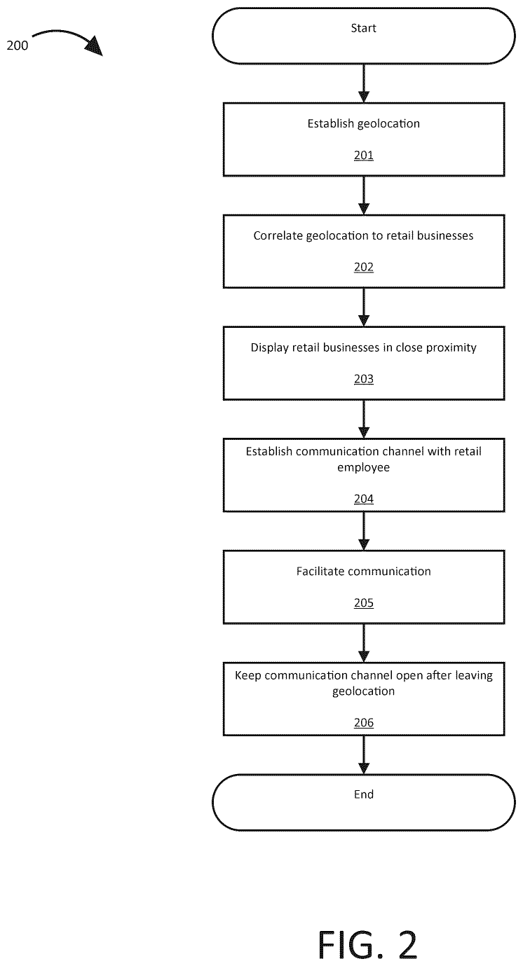

FIG. 2 is a flowchart of the process from the perspective of the customer device. The general interaction is described in the following sentences. First, a customer taps on a specific department and posts a question/request to talk to an employee (the customers can only see their own message, an automatic message can appear that an employee will get to them shortly). Second, all of the employees get a notification and can see the customer request in a group chat. This, one of the employees taps on the message with the customer, which opens up a 1on1 chat. When in chat, they can accept to help this specific customer by clicking a button “help this customer”, which initiates the chat and removes this customer request from the list of unhandled customers in the bucket. Fourth, In the chat they can agree on meeting in a specific department or just chat online.

In particular, from the customer perspective, the process begins at 201, when the geolocation is determined. The geolocation can be derived from the GPS system on the customer device (e.g., an iPhone). Using the geolocation, the platform can determine which stores are nearby. For example, the platform can access a database of addresses or coordinates (e.g., Google maps API). At 203, the platform can display the nearby stores. In some embodiments, the customer can search for stores, in addition to or as an alternate to having the platform auto-populate the nearby stores.

At 204, the platform can open a communication channel between the customer and a retail employee based on the customer's selection (e.g., a product or section). At 205, the platform can facilitate the conversation via text, voice, video, or other communication means. After the interaction is completed, at 206, the platform keeps the communication channel open even after the customer has left the location.

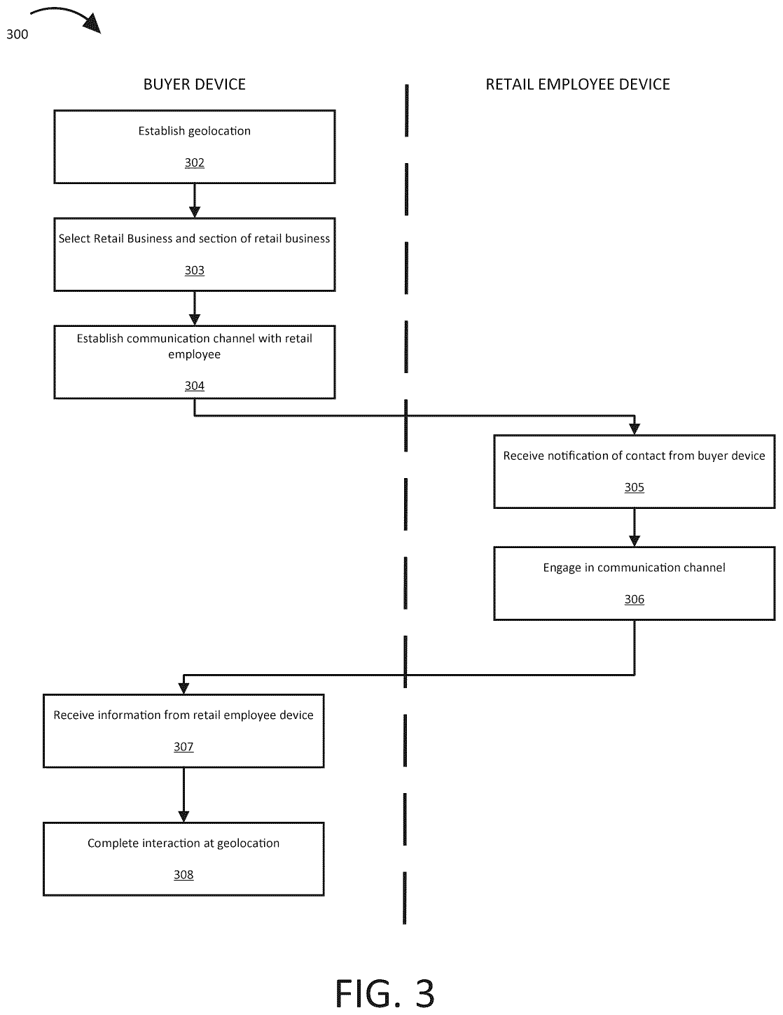

FIG. 3 is a block diagram of the exchange between the customer and retail employee devices. Blocks 302, 303 and 304 are similar to blocks 202, 203, and 204 of FIG. 2. At 305, the employee can receive notification indicating that a customer has posted a request on the platform. In response, the employee can engage in the communication channel at 306. This can include, as mentioned above, answering the request, facilitating a purchase, arranging an in-person meeting, a video call, or other forms of communication. In return, at 307, the customer sees the response and completes the interaction at 308.

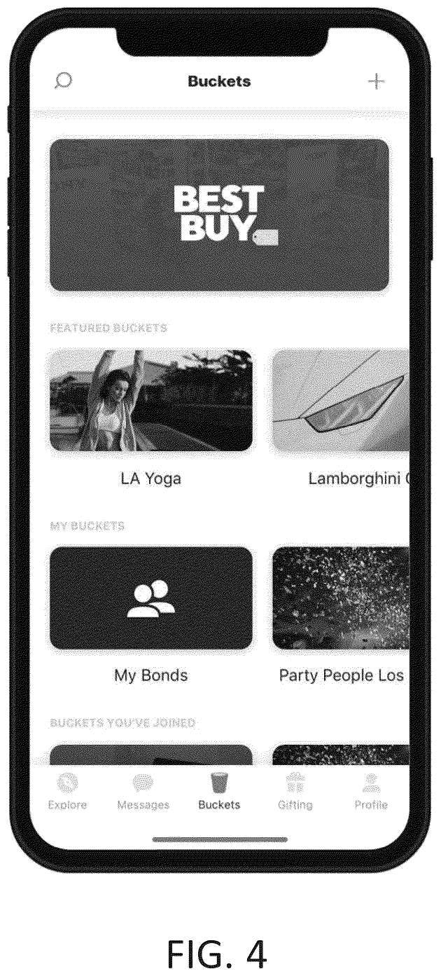

FIG. 4 is an embodiment of a graphical user interface from a customer perspective. In this embodiment, the interface indicates that the customer is near a Best Buy. As such, the customer can click on the Best Buy icon, and proceed in the manner described herein.

In some embodiments, the platform includes other GUIs based on the customers retail history, interests, location, and profile. For example, in addition to being in proximity to a Best Buy, the customer may also be in proximity to an LA Yoga. In some embodiments, LA Yoga can be a group that the customer is affiliated with that may contribute to the products or services that the customer is interested in.

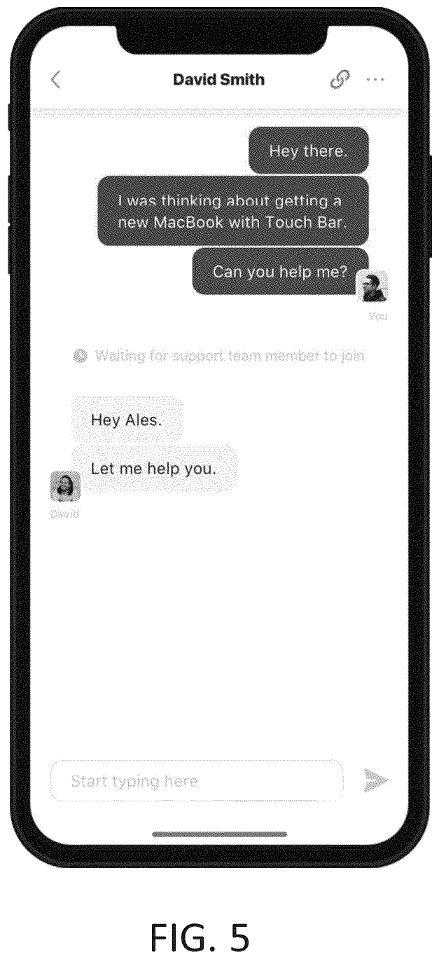

FIG. 5 is an embodiment of a chat GUI. Once the customer has selected the Best Buy icon, the customer can enter a chat conversation with a Best Buy employee. Here, the customer wants to buy a new MacBook. As such, David Smith, an employee of the nearby Best Buy has responded and will help the customer with the purchase.

### System

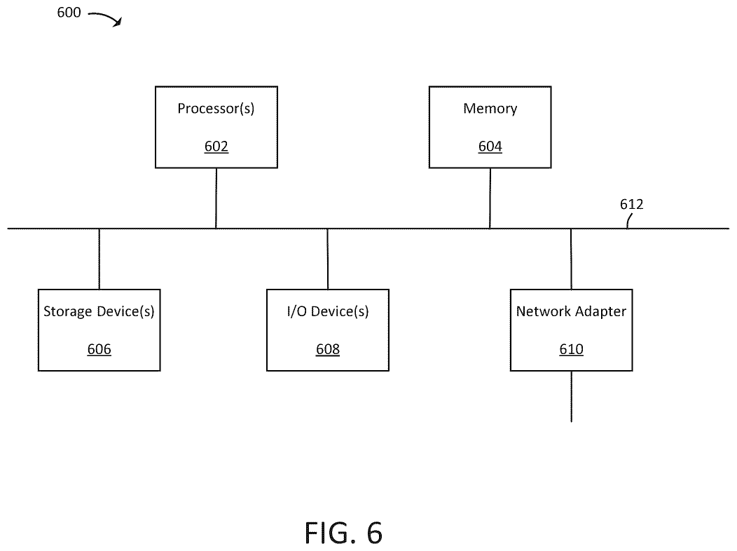

FIG. 6 is a block diagram of a computer system that may be used to implement features of some of the disclosed technology. The computing system 600 may be a modular reporting device, a reporting system, a server computer, a client computer, a personal computer (PC), a user device, a tablet PC, a laptop computer, a personal digital assistant (PDA), a cellular telephone, an IPHONE, an IPAD, a BLACKBERRY, a processor, a telephone, a web appliance, a network router, switch or bridge, a console, a handheld console, a (handheld) gaming device, a music player, any portable, mobile, handheld device, wearable device, or any machine capable of executing a set of instructions, sequential or otherwise, that specify actions to be taken by that machine.

The computing system 600 may include one or more central processing units (“processors”) 602, memory 604, input/output devices 606 (e.g., keyboard and pointing devices, touch devices, display devices), storage devices 608 (e.g., disk drives), and network adapters 610 (e.g., network interfaces) that are each connected to an interconnect 612. The interconnect 612 is illustrated as an abstraction that represents any one or more separate physical buses, point to point connections, or both connected by appropriate bridges, adapters, or controllers. The interconnect 612, therefore, may include, for example, a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (i.e., FIREWIRE).

The memory 604 and storage devices 608 are computer-readable storage media that may store instructions that implement at least portions of the various embodiments. In addition, the data structures and message structures may be stored or transmitted via a data transmission medium (e.g., a signal on a communications link). Various communications links may be used (e.g., the Internet, a local area network, a wide area network, or a point-to-point dial-up connection). Thus, computer readable media can include computer readable storage media (e.g. non-transitory media) and computer readable transmission media.

The instructions stored in memory 604 can be implemented as software and/or firmware to program the processor 602 to carry out actions described above. In some embodiments, such software or firmware may be initially provided to the computing system 600 by downloading it from a remote system through the computing system 600 (e.g., via network adapter 610).

The various embodiments introduced herein can be implemented by, for example, programmable circuitry (e.g. one or more microprocessors, programmed with software and/or firmware), or entirely in special-purpose hardwired circuitry (i.e., non-programmable circuitry), or in a combination of such forms. Special-purpose hardwired circuitry may be in the form of, for example, one or more application-specific integrated circuits (ASICs), programmable logic devices (PLDs), field-programmable gate array (FPGAs), etc.

### Additional Methods of Use

Retail stores often have websites or applications that allow potential customers to see details regarding the products available for sale and/or the store itself. Interaction with such websites tends to be restricted to viewing product details such price, dimensions, delivery time, and other related details, or general information about the store such as hours and scheduled sales. While customers may have personal accounts associated with the online store website, these accounts conventionally only are used for purchases and occasional announcements (via e-mail or mobile telephone number SMS). Customers generally do not interact with each other using their accounts registered to online stores.

Systems and methods for networking customer devices with each other and with retail location servers are described herein. A server (e.g., a server associated with a retail location) may determine that a first device is in proximity of a retail location, where the first device is associated with a customer user. To determine that the first device is in proximity of the retail location, a geolocation of the first device may be determined. A geofence may then be generated around the retail location, and the first device is in proximity when the first device is within the geofence. The server may then transmit a first set of data indicative of a customer graphical user interface (GUI) to the first device, where the customer GUI includes data indicative of products sold in the retail location and sections of the retail location. Instructions may then be transmitted by the server to display the customer GUI on a display of the first device. The customer GUI may be a part of a webpage or web application window being accessed via the Internet. The server may then subsequently transmit, via the customer GUI, an invitation to join a private circle associated with the retail location. In response to the customer selecting, on the customer GUI, a confirmation of joining the private circle, a circle GUI may be transmitted to the first device providing selectable links to other customer users and event webpages. The links to the other customer users may be associated with user accounts that have also been detected within the geofence.

In some embodiments, interactions between customer devices and retail location servers may be tracked to provide real-time analytic data. Interaction data generated by the customer user interacting with the customer GUI may be stored, along with communication data generated by communications between customer users and employees. A real-time analytics dataset may then be generated based on at least one of the interaction data and metadata regarding the communication data. The server may then cause the real-time analytics dataset to be displayed on a display of a third device as part of an analytics GUI. The analytics GUI may be a part of a webpage or web application window accessed via the Internet.

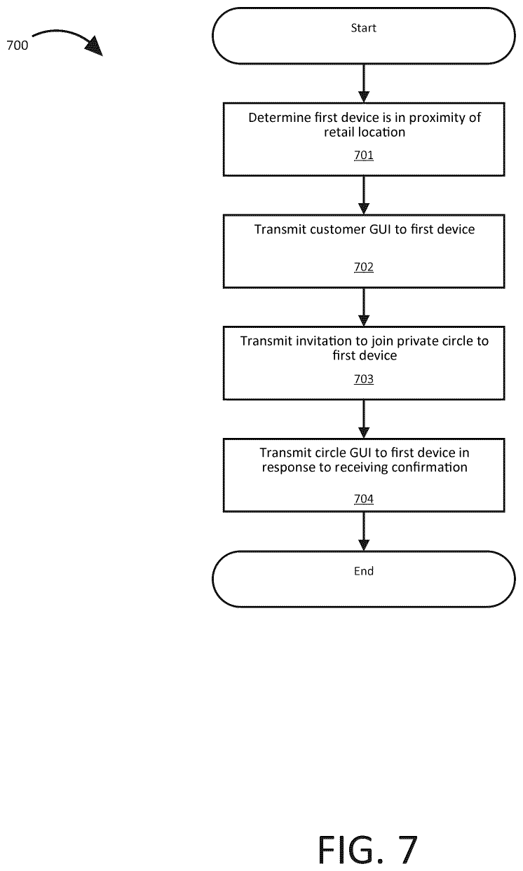

FIG. 7 shows a flow diagram of a method 700 of networking customer devices with each other and with retail location servers, according to an embodiment. A server (e.g., a server associated with a retail location, such as server 112) may determine that a first device (e.g., customer device 104) is in proximity of a retail location at step 701, where the first device is associated with a customer user. To determine that the first device is in proximity of the retail location, a geolocation of the first device may be determined, using one of the methods described above. A geofence may then be generated around the retail location, and the first device is determined to be in proximity of the retail location when the first device is within the geofence around the retail location.

The server may then transmit a first set of data indicative of a customer graphical user interface (GUI) to the first device at step 702, where the customer GUI includes data indicative of products sold in the retail location and sections of the retail location as described above. Instructions may then accordingly be transmitted by the server to display the customer GUI on a display of the first device. The customer GUI may be a part of a webpage or web application window being accessed via the Internet.

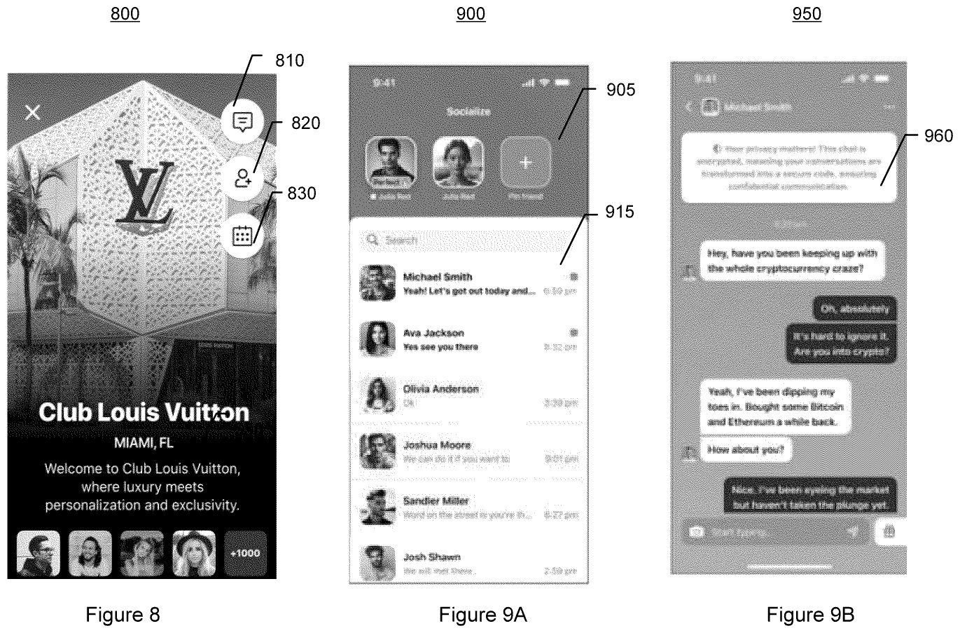

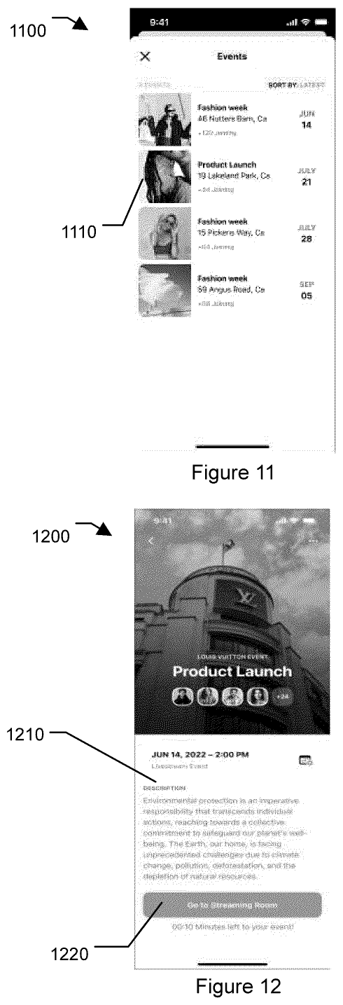

The server may then subsequently transmit, via the customer GUI, an invitation to join a private circle associated with the retail location at step 703. In response to the customer selecting, on the customer GUI, a confirmation of joining the private circle, a circle GUI may be transmitted to the first device providing selectable links to other customer users and event webpages at step 704. The links to the other customer users may be associated with user accounts that have also been detected within the geofence. FIG. 8 is a screenshot from a circle GUI 800 providing selectable links to other customer users and event webpages, according to an embodiment. As shown, circle GUI 800 includes a brief description of the theme of the circle, and selectable links 810, 820, and 830. Exemplary link 810 may connect the customer to employees of the retail location to chat, for example, regarding products or sections of the retail location. Selectable link 820 may connect the customer to other customer users within the geofence associated with the retail location. Selectable link 830 may be linked to event webpages, which are discussed further in the text accompanying FIGS. 11-12.

FIGS. 9A-B are screenshots from customer GUIs 900 and 950 that include selectable chat links to other customer users and a chat GUI respectively, according to various embodiments. Customer GUI 900 allows a customer user to connect to other customer users, and may be displayed in response to a user selecting link 820, for example, from the private circle GUI 800. Customer GUI 900 displays links 905 to pinned other customer users, and allows the customer user to pin additional customer users to the top of customer GUI 900. within the retail location geofence, as well as active chats 915 with other customer users (who may or may not currently be in the geofence of the retail location) who subscribe to the private circle.

Customer GUI 950 is a chat GUI, which may be displayed in response to selecting one of the active chats 915 in customer GUI 900. Chats between customer users may be established when one customer user requests to interact with the second customer on the customer GUI. In response to receiving a request to chat, the server may transmit a second set of data indicative of a chat GUI to a second device and instructions to display the chat GUI on a display of a second device associated with a second customer user. The server may then establish a communications channel between the first device and the second device in response to the second device confirming that the second customer user wishes to chat with the first customer user. Further in response to the establishing the communication channel, the chat GUI (e.g., chat GUI 950) may be to the second device and the first device. Message 960 confirms that the communications transmitted using the chat GUI are encrypted. The communications channel being encrypted using a predetermined encryption library, which may be any suitable encryption library for real-time chat communications (e.g., Seald, provided by Seald SAS of Bougival, France).

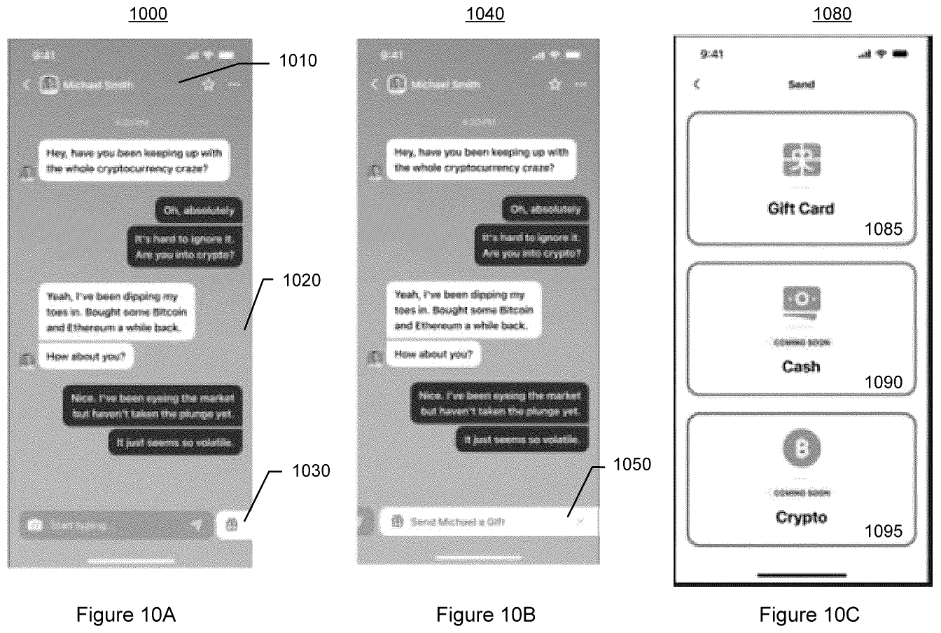

The chat GUI may include selectable options to send store credit or gift cards for the retail location or electronic currency from the customer user to the second customer user in some embodiments. FIGS. 10A-C are screenshots from chat GUIs 1000, 1040, and 1080 displaying a process for gifting gift cards to a retail location, electronic currency, and/or cryptocurrency, according to various embodiments. Chat GUI 1000 includes an identifier 1010 of the second customer user engaged in the chat and one or more messages 1020 relayed via the chat using the server associated with the retail location. Chat GUI 1000 also includes selectable icon 1030 for sending a gift to the second customer user. The selectable icon 1030 may be expanded into selectable link 1050 in chat GUI 1040 in some embodiments. When link 1050 is selected from chat GUI 1040, gift GUI 1080 may be displayed on the first device. Gift GUI 1080 includes three selectable options for gifts to the second customer user: gift card/store credit icon 1085, cash icon 1090, and cryptocurrency icon 1095. When any of the selectable options in gift GUI 1080 are selected, the user may be redirected to an interface allowing the user to select an amount to transfer, and request that the transfer be executed by the server. The server associated with the retail location may then communicate with a corresponding payments server to execute a gift transfer. In an exemplary embodiment, each gift option may be linked using an API to request the gift from the corresponding payments server. Once the transaction is completed by the payments server, the server associated with the retail location may log the gift transaction. For example, the gift transaction may be logged in the giving user's text messaging feed and/or in a designated wallet interface that lists all gift transactions (both given and received) associated with the user.

As noted above, the circle GUI may include selectable links to event webpages for exclusive subscriber-only events. FIG. 11 is a screenshot from a customer GUI 1100 that includes multiple selectable links to event webpages, according to an embodiment. Customer GUI 1100 may be displayed in response to selecting event link 830 on the circle GUI. Selectable link 1110 is one of a plurality of event links displayed, and the display may take any suitable form (e.g., a calendar, a searchable/filterable list, etc.). FIG. 12 is a screenshot from a customer GUI 1200 displaying a livestreamed event, according to an embodiment. Customer GUI 1200, in this case an event webpage, may include a description 1210 of the event, and a selectable link 1220 to the event, when the event is a virtual event. Link 1220 may link directly to a livestreamed event webpage, where the livestreamed event webpage includes video content highlighting selected products and/or sections of the retail location.

As some events described in event webpages may take place physically in the retail location, selectable link 1220 may not be present in all event webpages. Furthermore, while event webpage 1200 may be displayed in response to selecting link 1110, other ways of presenting event webpages via the circle GUI may be used. For example, event webpages and/or sale webpages may be automatically displayed on the circle GUI in response to the first device entering proximity to the retail location in some embodiments.

While circles describe above relate to associated retail locations, users are not restricted to such circles and can create their own circles using the server. Such private circles may include invite-only groups of users, where privacy is data regulation compliant. The private circles may include friend lists of affiliated users, and further include GUIs to highlight conversations similar to the chat GUIs discussed above.

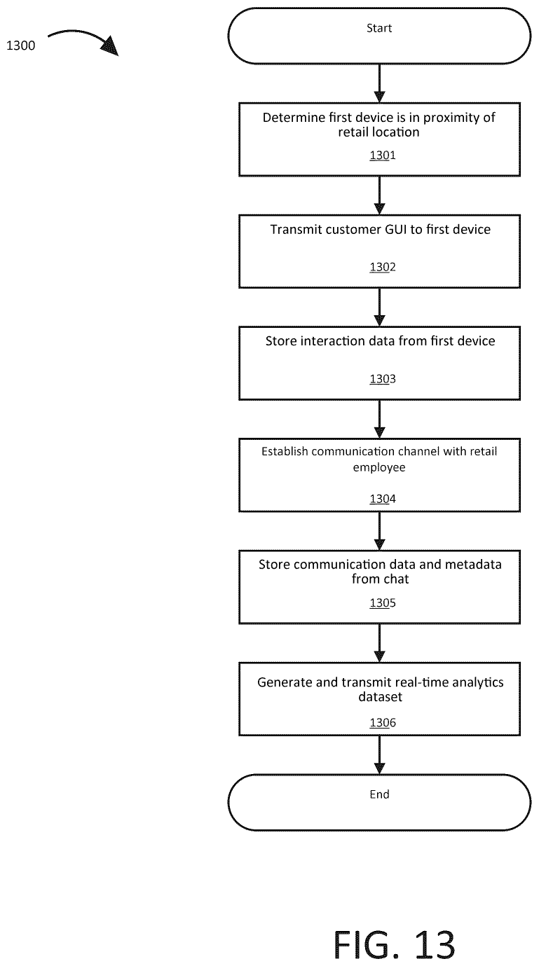

In some embodiments, interactions between customer devices and retail location servers may be tracked to provide real-time analytic data. Interaction data generated by the customer user interacting with the customer GUI may be stored, along with communication data generated by communications between customer users and employees. A real-time analytics dataset may then be generated based on at least one of the interaction data and metadata regarding the communication data. FIG. 13 shows a flow diagram of a method 1300 of tracking interactions between customer devices and retail location servers, according to an embodiment. A server (e.g., a server associated with a retail location, such as server 112) may determine that a first device (e.g., customer device 104) is in proximity of a retail location at step 1301, where the first device is associated with a customer user. To determine that the first device is in proximity of the retail location, a geolocation of the first device may be determined, using one of the methods described above. A geofence may then be generated around the retail location, and the first device is determined to be in proximity of the retail location when the first device is within the geofence around the retail location.

The server may then transmit a first set of data indicative of a customer graphical user interface (GUI) to the first device at step 1302, where the customer GUI includes data indicative of products sold in the retail location and sections of the retail location as described above. Instructions may then accordingly be transmitted by the server to display the customer GUI on a display of the first device. The customer GUI may be a part of a webpage or web application window being accessed via the Internet. At least a portion of the real-time analytic data may then be generated by storing, by the server, interaction data generated by the customer user interacting with the customer GUI at step 1303. The interaction data may include any data used to track engagement with the customer GUI, including GUI usage (number of users per time period) and/or views, login activity, the time spent using the GUI, time spent within the geofence associated with the retail location, retention, social activity of each user (e.g., gift activity, connections made to other customer users), user identity information (e.g., country/state/city associated with each user in the geofence, occupation, social interests, etc.), information about the first device used to access the retail location web platform, GUI usage during the time spent within the geofence, product and/or section webpage viewing information, sale data, etc. To protect customer privacy, in some embodiments the storing the interaction data may be ended by the server in response to detecting that the first device has exited the geofence associated with the retail location.

In addition to customer GUI interaction with the web site and/or web application associated with the retail location, chat interactions may also be tracked for the real-time analytics data. At step 1304, the platform can open a communication channel between the customer user and a retail employee based on the customer's selection of a product or section webpage of the web site/application. The chat conversation may take place via text, voice, video, or other suitable communications technology, as described above. In addition to storing the chat communication data itself, the server may also log metadata regarding the communication data at step 1305. The metadata may include information such as the identity of the employee involved in the chat, how long the chat took place, a qualitative assessment of the chat based on natural language recognition (i.e. if the chat was positive, negative or neutral), the time of day the chat occurred, etc. Access to these metrics allows retailers or circle owners to monitor the tone of chat interactions and respond accordingly.

Then, at step 1306, a real-time analytics dataset including the interaction data and/or the metadata regarding the communication data may be generated by the server from the tracked interactions and communication data. Data collection may be triggered by events occurring at the retail location. For example, collection of data for the real-time analytics dataset may be triggered by a customer device entering the geofenced area. Another triggering event may be the initiation of a chat session between the customer device and an employee device via the retail location website within the geofenced area. In addition to collecting interaction data and communication data and metadata, the real-time analytics dataset may include correlations and trends between different metrics to provide a holistic view of user behavior. For example, the relationship between chat sessions, response time, and chat sentiment may be analyzed using the real-time analytics dataset to optimize customer support and enhance user experience. Furthermore, specific goals may be defined with each metric, such as reducing bounce rates or increasing chat session duration, to drive actionable improvements. The real-time analytics dataset may also be used to monitor churn rate to reduce customer attrition and calculate Customer Acquisition Cost (CAC) relative to subscription revenue to assess the ROI of marketing efforts.

The real-time analytics dataset may then be displayed on a display of a third device (e.g., a retail location computing device) as part of an analytics GUI. The analytics GUI may be a part of a webpage or web application window being accessed via the Internet. In some embodiments, the real-time data may not be integrated with existing data, and may be tracked and used only while the customer device is within the geofenced area. This may advantageously reduce data storage costs, and make any actions taken based on the real-time analytics data set more responsive to what is going on at the retail location, thereby better tailoring the response of the server, the circle owner, and/or the retail location to the customer device's behavior.

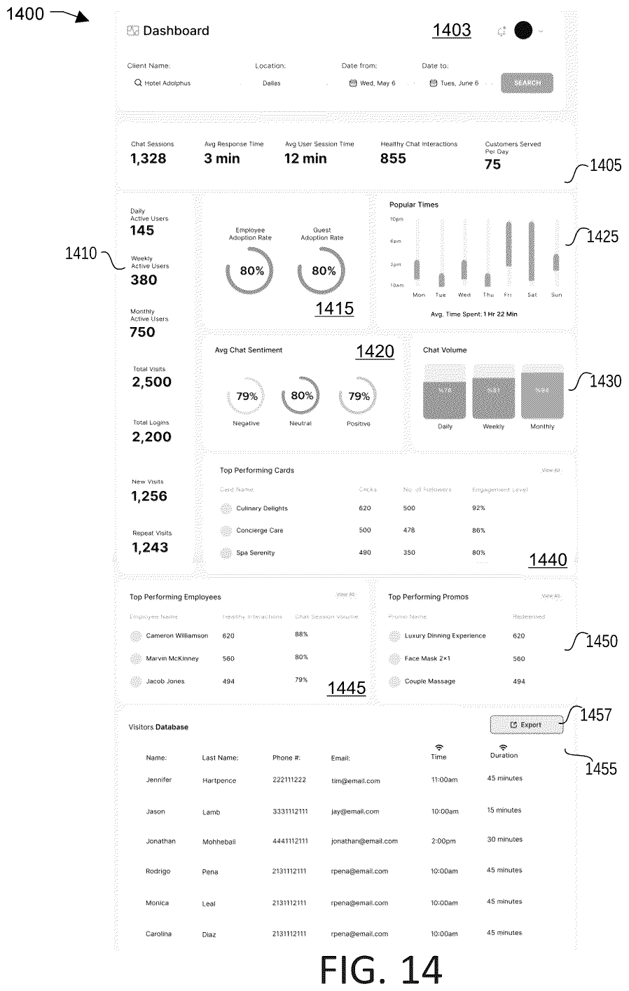

In some embodiments, data from the real-time analytics dataset may be extracted and included in an analytics GUI dashboard that allows users to make data-driven decisions, improve user experience, enhance operational efficiency, and ultimately impact Return on Investment (ROI). FIG. 14 is a screenshot from an analytics GUI 1400 displaying information from a real-time analytics dataset, according to an embodiment. Analytics GUI 1400 captures actionable metrics and key performance indicators from the real-time analytics dataset. As shown in analytics GUI 1400, interaction data, as shown in elements 1410, 1415, 1425, 1440, 1450, and 1455 may be tracked in real-time, stored in an analytics dataset, and displayed on any third device that requests the data. As shown in the analytics GUI 1400, actionable metrics and KPIs from the interaction data may include, but is not limited to daily users, weekly users, monthly users, average user session time, live users, new users, repeat users, chat sessions, average response time, healthy chat interactions, bounce rate, customers served, and average chat sentiment.

Similarly, communications metadata pertaining to chat sessions, as shown in elements 1405, 1420, 1430, and 1445, may also be tracked in real-time and displayed. As shown, the communications metadata may include sentiment analysis to measure customer satisfaction levels during interactions with employees (e.g., by calculating net promoter score). A chat summary feature may also be used to extract valuable insights from customer conversations and identify positive and negative comments related to products and interests that can guide inventory adjustments. Additional metrics from the communications metadata may include top employees, top users, conversion rate, customer sentiment, chat summary insights, and product insights.

The analytics GUI 1400 may include additional functionality, in addition to displaying data from the real-time analytics dataset. For example, the dashboard 1400 may incorporate the ability to filter underlying data presented on one or more dimensions. As shown in search bar 1403, dashboard 1400 may include date filters, allowing users to select specific date ranges or time frames to review and analyze data. Users may also have the ability to select multiple store locations from the search bar 1403 within the dashboard 1400, where specific stores or regions may be isolated or grouped together for analysis and comparison. In some embodiments, a comparative dashboard may be used to create side-by-side comparisons between two or more stores or regions. This feature will provide a visual representation of key metrics, making it easier to identify performance disparities, best practices, and areas for improvement across different locations. The analytics GUI may also be implemented as a live dashboard that provides up-to-the-minute updates on critical metrics such as live users, chat sessions, and customer sentiment, empowering the client to respond promptly to emerging trends or issues. Moreover, any data displayed in a dashboard may be translated and exported (e.g., using selectable export link 1457) as a report in any of a plurality of file formats (e.g., .pdf, .xlsx, .ods) to facilitate sharing with different devices. By offering advanced filtering, comparative analysis, and live monitoring, the dashboard will empower users to make informed decisions, drive improvements, and maximize the benefits of their analytics efforts. Such improvements may translate into improved operational efficiency, better user engagement with the website associated with the retail location, and better inventory management (e.g., from product-related chat summaries and customer interests expressed in circles), for example.

The real-time analytics data may be used in a variety of ways to improve the retail location's engagement with their web platform. For example, in some embodiments the interaction data may be monitored for one or more tracked metrics. In response to the monitored interaction data meeting a predetermined threshold, the server may transmit, via the customer GUI, a sale webpage to the first device. The monitored interaction data May include number of customers within the geofence hitting a threshold number, a number of sales at the retail location, or a webpage associated with a product or section of the retail location having a predetermined number of visits within a predetermined time period (e.g. one hour, or half of the work day). In some embodiments, the server may receive, from the third device via the Internet, a request to broadcast a sale event to customer devices within the geofence associated with the retail location after receiving the analytics GUI. In response to receiving the request, the server may transmit the sale event to the first device (e.g., via a pop-up sale webpage that includes links to the products or sections that the sale event is applicable to).

### Conclusion

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference herein to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A method for networking customer devices with each other and with retail location servers comprising:
determining, by a server, that a first device is in proximity of a retail location, the first device being associated with a customer user, wherein determining that the first device is in proximity further includes:
determining a geolocation of the first device;
generating a geofence around the retail location; and
determining that the first device is within the geofence;
transmitting, by the server, a first set of data indicative of a customer graphical user interface (GUI) to the first device, wherein the customer GUI includes data indicative of products sold in the retail location and sections of the retail location;
transmitting, by the server, instructions to display the customer GUI on a display of the first device, the customer GUI being a part of a webpage or web application window being accessed via the Internet;
subsequently transmitting, by the server via the customer GUI, an invitation to join private circle associated with the retail location; and
in response to the customer selecting, on the customer GUI, a confirmation of joining the private circle, transmitting, by the server, a circle GUI providing selectable links to other customer users and event webpages, the links to the other customer users being associated with user accounts that have also been detected within the geofence.

2. The method of claim 1, further comprising:
transmitting, by the server, a second set of data indicative of a chat GUI to a second device and instructions to display the chat GUI on a display of a second device associated with a second customer user in response to receiving a user request to interact with the second customer on the customer GUI;
establishing, by the server, a communications channel between the first device and the second device, and
further in response to the establishing the communication channel, transmitting the chat GUI to the second device.

3. The method of claim 2, the communications channel being encrypted using a predetermined encryption library.

4. The method of claim 2, the chat GUI comprising selectable options to send store credit or gift cards for the retail location or electronic currency from the customer user to the second customer user.

5. The method of claim 1, further comprising:
storing, by the server, interaction data generated by the customer user interacting with the customer GUI;
generating, by the server, a real-time analytics dataset comprising the interaction data tracked over a predetermined period of time; and
transmitting, by the server, instructions to display the real-time analytics dataset on a display of a third device as part of an analytics GUI, the analytics GUI being a part of a webpage or web application window being accessed via the Internet.

6. The method of claim 1, the customer GUI being part of an application installed on the first device, further comprising, during a set-up of the application, receiving, by the server, data identifying the customer as a customer user.

7. The method of claim 1, further comprising displaying at least one of event webpages and sale webpages on the customer GUI in response to the first device entering proximity to the retail location.

8. The method of claim 1, the customer GUI further comprising a selectable link to a livestreamed event, the livestreamed event comprising video content highlighting selected products and/or sections of the retail location.

9. A computer program product, comprising a non-transitory computer-readable medium having a computer-readable program code embodied therein to be executed by one or more processors, the program code including instructions to:
determine that a first device is in proximity of a retail location, the first device being associated with a customer user, wherein determining that the first device is in proximity further includes:
determining a geolocation of the first device;
generating a geofence around the retail location; and
determining that the first device is within the geofence;
transmit a first set of data indicative of a customer graphical user interface (GUI) to the first device, wherein the customer GUI includes data indicative of products sold in the retail location and sections of the retail location;
transmit instructions to display the customer GUI on a display of the first device, the customer GUI being a part of a webpage or web application window being accessed via the Internet;
subsequently transmit, via the customer GUI, an invitation to join private circle associated with the retail location; and
in response to the customer selecting, on the customer GUI, a confirmation of joining the private circle, transmit a circle GUI providing selectable links to other customer users and event webpages, the links to the other customer users being associated with user accounts that have also been detected within the geofence.

10. The computer program product of claim 9, the program code further including instructions to:
transmit a second set of data indicative of a chat GUI to a second device and instructions to display the chat GUI on a display of a second device associated with a second customer user in response to receiving a user request to interact with the second customer on the customer GUI;
establish a communications channel between the first device and the second device, and
further in response to the establishing the communication channel, transmit the chat GUI to the second device.

11. The computer program product of claim 10, the communications channel being encrypted using a predetermined encryption library.

12. The computer program product of claim 10, the chat GUI comprising selectable options to send store credit or gift cards for the retail location or electronic currency from the customer user to the second customer user.

13. The computer program product of claim 9, the program code further including instructions to:
store interaction data generated by the customer user interacting with the customer GUI;
generate a real-time analytics dataset comprising the interaction data tracked over a predetermined period of time; and
transmit instructions to display the real-time analytics dataset on a display of a third device as part of an analytics GUI, the analytics GUI being a part of a webpage or web application window being accessed via the Internet.

14. The computer program product of claim 9, the customer GUI being part of an application installed on the first device, further comprising, during a set-up of the application, receiving, by the server, data identifying the customer as a customer user.

15. A method for tracking interactions between customer devices and retail location servers comprising:
determining, by a server, that a first device is in proximity of a retail location, the retail business being associated with the employee and the first device being associated with a customer user, wherein determining that the first device is in proximity further includes:
determining a geolocation of the first device;
generating a geofence around the retail location; and
determining that the first device is within the geofence;
transmitting, by the server, a first set of data indicative of a customer graphical user interface (GUI) to the first device, wherein the customer GUI includes data indicative of products sold in the retail location and sections of the retail location;
transmitting, by the server, instructions to display the customer GUI on a display of the first device, the customer GUI being a part of a webpage or web application window being accessed via the Internet;
storing, by the server, interaction data generated by the customer user interacting with the customer GUI;
transmitting, by the server, a second set of data indicative of an employee GUI to a second device associated with the employee and instructions to display the employee GUI on a display of the second device, the employee GUI being a part of a webpage or web application window being accessed via the Internet;
in response to the customer selecting, on the customer GUI, a first product or a first section, establishing, by the computing device server, a communication channel between the first device and the second device via the Internet, wherein the employee is associated with the first product or first section;
in response to establishing the communication channel, transmitting, by the server, a chat GUI to the first device and the second device, wherein the chat GUI is operable to transmit communication data over the communication channel;
storing, by the server, the communication data from the chat GUI and metadata regarding the communication data;
generating, by the server, a real-time analytics dataset comprising at least one of the interaction data and the metadata regarding the communication data; and
transmitting, by the server, instructions to display the real-time analytics dataset on a display of a third device as part of an analytics GUI, the analytics GUI being a part of a webpage or web application window being accessed via the Internet.

16. The method of claim 15, further comprising:
monitoring the interaction data; and
in response to the monitored interaction data meeting a predetermined threshold, transmitting, via the customer GUI, a sale webpage to the first device.

17. The method of claim 16, the monitored interaction data comprising a number of times the customer GUI is loaded by devices within the retail location.

18. The method of claim 16, the monitored interaction data comprising a number of sales made within the retail location over a predetermined period of time.

19. The method of claim 15, further comprising receiving, by the server from a third device via the Internet, a request to broadcast a sale event to customer devices within the geofence associated with the retail location, and, in response to receiving the request, transmitting, by the server, the sale event to the first device.

20. The method of claim 15, further comprising ending the storing the interaction data in response to detecting, by the server, that the first device has exited the geofence associated with the retail location.
